(19) United States
(12) Patent Application Publication
(10) Pub. No.: US 2013/0311888 A1
(43) Pub. Date: Nov. 21, 2013

(54) Arranging a Set of Panels in a First Application Environment Via Arrangement of the Set of Panels in a Second Application Environment for a Multi-Modal Device

(71) Applicants: Nirmalya Barat, Cupertino, CA (US); Parikshit Dharawat, Sunnyvale, CA (US); Vamshika R. Gangam, San Jose, CA (US); Ji Hye Jung, Palo Alto, CA (US)

(72) Inventors: Nirmalya Barat, Cupertino, CA (US); Parikshit Dharawat, Sunnyvale, CA (US); Vamshika R. Gangam, San Jose, CA (US); Ji Hye Jung, Palo Alto, CA (US)

(73) Assignee: Motorola Mobility, Inc., Libertyville, IL (US)

(21) Appl. No.: 13/473,661

(22) Filed: May 17, 2012

(51) Int. Cl. G06F 3/048

(52) U.S. Cl. 715/733

(57) ABSTRACT

A method for arranging a set of panels in a first application environment via arrangement of the set of panels in a second application environment includes receiving a request by a first application environment for configuration information for a set of panels of the first application environment from a second application environment, and receiving by the second application environment the configuration information. The method includes displaying the set of panels in a user interface of the second application environment based on the configuration information, and receiving, via the user interface, an input for changing one of the panels. The method includes receiving a request, by the first application environment, for changing the one panel in the first application environment from the second application environment, and changing the one panel in the first application environment to match the change of the one panel in the second application environment.

### BACKGROUND

Particular embodiments generally relate to managing applications that operate on a multi-modal device.

Multi-modal devices, such as mobile communication devices, personal digital assistants (PDAs), etc., have relatively powerful computing capability for operating a variety of applications. Further, multi-modal devices also have relatively large memories that can store a relatively large number of applications. With the current number of applications that a multi-modal device can store and operate, managing the applications has become a burden for users.

Managing applications on a multi-modal device may include loading applications, loading application updates, creating a favorite list of applications, moving icons for launching applications to selected panels or a docking bar, etc. Multi-modal devices provide tools for managing applications. However, the tools provided by a multi-modal device for managing an application typically require that a user provide numerous inputs to a multi-modal device to manage the application. For example, a user interacting with a touch screen of a multi-modal device may be required to make several gestures (e.g., taps, swipes, etc.) on the touch screen to move an icon for an application from a list of applications on the multi-modal device to a panel or a docking bar. For example, several gestures may be required to open the list of applications from a list menu where the list menu may be a submenu of another menu. Several gestures may be required to select the application from the list. Several more gestures may thereafter be required to a select a particular panel on which to place the icon for the application.

Multi-modal device's also have relatively small displays which also makes the number of gestures used for managing icons applications relatively large. The relatively small display of a multi-modal device generally displays a single panel that is sufficiently large for managing icons. Some multi-modal devices display multiple panels on the multi-modal devices' displays; however, the multiple panels are relatively small, which inhibits efficient managing of icons.

### BRIEF DESCRIPTION OF THE DRAWINGS

FIG. 1 depicts an example of a multi-modal device coupled to a hardware module via a dock.

FIG. 2 depicts a software environment of the multi-modal device according to one embodiment.

FIG. 3 depicts a system diagram of the multi-modal device according to one embodiment.

FIG. 4 depicts a high-level flow diagram of a method for arranging a panel in the set of panels in first application environment via arrangement of the panel in second application environment according to one embodiment.

### DETAILED DESCRIPTION

Described herein are techniques for managing applications on mobile communication devices. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

According to one embodiment, a method operable on a multi-modal device is provided for arranging a set of panels in a first application environment via arrangement of the set of panels in a second application environment. The method includes detecting a docking of the multi-modal device to a hardware module, and displaying, in response to the docking, on the hardware module a user interface for the second application environment operating on the multi-modal device. The method further includes receiving a request, at the first application environment, for configuration information for the set of panels of the first application environment from the second application environment, and sending, from the first application environment, the configuration information to the second application environment. The method further includes displaying in the user interface for the second application environment the set of panels based on the configuration information, and receiving, via the user interface, an input to change at least one of the panels in the second application environment. The method further includes receiving a request, at the first application environment, for changing the at least one of the panels in the first application environment from the second application environment based on the input, and making a change to the at least one of the panels in the first application environment to match the change of the at least one of the panels in the second application environment based on the request for changing the at least one of the panels.

According to another embodiment, a non-transitory computer-readable storage medium comprises instructions for arranging a set of panels in a first application environment via arrangement of the set of panels in a second application environment, the instructions for controlling a multi-modal device to be operable for: detecting a docking of the multi-modal device to a hardware module; displaying, in response to the docking, on the hardware module a user interface for the second application environment operating on the multi-modal device; receiving a request, at the first application environment, for configuration information for the set of panels of the first application environment from the second application environment; sending, from the first application environment, the configuration information to the second application environment; displaying in the user interface for the second application environment the set of panels based on the configuration information; receiving, via the user interface, an input to change at least one of the panels in the second application environment; receiving a request, at the first application environment, for changing the at least one of the panels in the first application environment from the second application environment based on the input; and making a change to the at least one of the panels in the first application environment to match the change of the at least one of the panels in the second application environment based on the request for changing the at least one of the panels.

According to another embodiment, a multi-modal device for arranging a set of panels in a first application environment via arrangement of the set of panels in a second application environment includes a processor for operating the first application environment and the second application environment. The multi-modal device further includes a non-transitory computer readable medium for storing instructions for controlling the processor to be operable for: detecting a docking of the multi-modal device to a hardware module; displaying, in response to the docking, on the hardware module a user interface for the second application environment operating on the multi-modal device; receiving a request, at the first application environment, for configuration information for the set of panels of the first application environment from the second application environment; sending, from the first application environment, the configuration information to the second application environment; displaying in the user interface for the second application environment the set of panels based on the configuration information; receiving, via the user interface, an input to change at least one of the panels in the second application environment; receiving a request, at the first application environment, for changing the at least one of the panels in the first application environment from the second application environment based on the input; and making a change to the at least one of the panels in the first application environment to match the change of the at least one of the panels in the second application environment based on the request for changing the at least one of the panels.

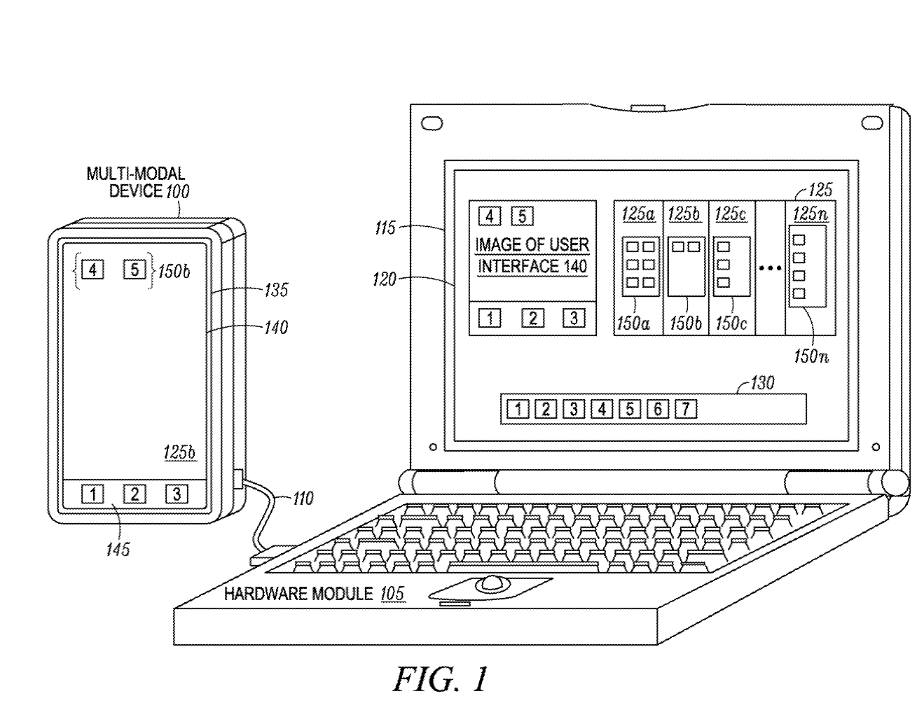

FIG. 1 depicts an example of a multi-modal device 100 coupled to a hardware module 105 via a dock 110. Multi-modal device 100 may be a mobile telephone, such as a smartphone, a personal digital assistant, or the like. Hardware module 105 may be a monitor, such as a television or a stand-alone monitor configured to be used with a computing device. According to an embodiment where hardware module 105 is a monitor, the monitor may be a “dumb” monitor having little or no computer operating capabilities. According to some embodiments, the monitor may have a touch interface.

According to an alternative embodiment, hardware module 105 may be a computing device, such as a personal computer, a laptop computer, a tablet computer, a server computer operating a server operating system, or the like. According to an embodiment where hardware module 105 is a computing device, the computing device may include an integrated monitor (e.g., a laptop computer, tablet computer, etc.) or a stand-alone monitor, which operates in conjunction with the computing device (e.g., desktop computing device with stand-alone monitor). In FIG. 1, hardware module 105 is depicted as a laptop computer.

Hardware module 105 includes a display 115 that displays a user interface 120. User interface 120 displays a set of panels 125 (labeled 125a, 125b . . . 125n in FIG. 1) and a docking bar 130 according to one embodiment.

Multi-modal device 100 includes a display 135 that displays a user interface 140. User interface 140 may display a selected panel (e.g., panel 125b) from the set of panels 125. User interface 140 may also display a docking bar 145. Each panel in the set of panels 125 is associated with a set of home screen objects. The sets of home screen objects are labeled 150a, 150b . . . 150n in FIG. 1 and are respectively associated with panels 125a, 125b . . . 125n. If a selected panel from the set of panels 125 is displayed on user interface 140, the set of home screen objects associated with the selected panel is displayed in the selected panel of user interface 140. For example, the set of home screen objects 150b that is associated with panel 125b is shown in panel 125b in FIG. 1.

Home screen objects may include launcher objects (e.g., shortcuts, such as application shortcuts for applications, bookmarks, etc.), widgets, folders, wallpaper, etc. An application shortcut may be associated with an application that operates on multi-modal device 100 and may include graphics and/or text, which identifies that application. A bookmark may be link. For example, a bookmark may be a link to a website, or the like. A widget includes a graphic on a panel and may provide status information (e.g., clock, calendar, weather, etc.), may provide an option to change a setting (turn Wi-Fi on/off, turn airplane mode on/off, etc.), may add function to a panel, etc. A folder may be a folder for application shortcuts, bookmarks, other folders, etc. A shortcut may be a link or a pointer to files, applications, data, etc. A home screen object may be associated with an item identified by the home screen object. For example, a home screen object that is an application icon may be associated with an application represented by the application icon. According to another example, a home screen object that is a bookmark may be associated with the link represented by the bookmark. As is well known in the art, if a home screen object is selected, the home screen object initiates the launch of the item associated with the launcher icon. For example, if the home screen object is for an application, selection of the home screen object may initiate the launching of the application.

According to one embodiment, user interface 120 displays the set of panels 125 and docking bar 130 if multi-modal device 100 is docked to hardware module 105. According to a further embodiment, if multi-modal device 100 is docked to hardware module 105, manipulation of one or more of panels 125 on one of multi-modal device 100 and hardware module 105, causes the same manipulation to be displayed and/or performed on the other of multi-modal device 100 and hardware module 105. For example, if panel 125b is manipulated on multi-model device 100, the same manipulation is displayed on the image of panel 125b on hardware module 105 according to one embodiment. According to a further example, if a home screen object is added to panel 125b on multi-modal device 100, the home screen object is displayed in the image of panel 125b on hardware module 105. According to another example, if panel 125b is manipulated on hardware module 105, the same manipulation is displayed on panel 125b on multi-modal device 100. According to another example, if a home screen object is added to panel 125b on hardware module 105, the home screen object is added to panel 125b on multi-modal device 100.

Manipulations of the set of panels 125 may include the addition or removal of a panel from the set of panels. Manipulations of the set of panels 125 may also include the rearrangement of an order of the panels. Manipulations of the set of panels 125 are described in further detail below. Manipulations to the set of panels 125 may be stored in multi-modal device 100. Thereafter, the panels with the manipulations may be used and displayed by multi-modal device 100 when the multi-modal device is no longer docket with hardware module 105.

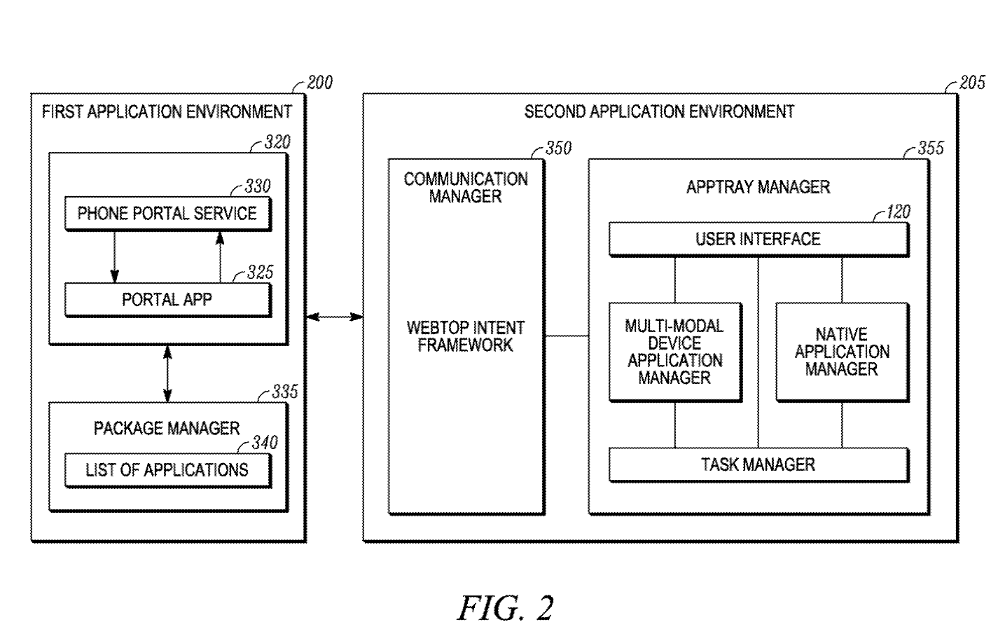

FIG. 2 depicts a software environment of multi-modal device 100 according to one embodiment. Multi-modal device 100 is configured to operate a first application environment 200 and a second application environment 205 according to one embodiment. An application environment may include frameworks, libraries, and services for supporting applications that operate in the application environment. An application environment may also provide a set of application program interfaces (APIs) used for runtime execution of applications developed with the APIs. An application environment may also provide a set of panels (e.g., set of panels 125) via which applications, frameworks, libraries, and services may be accessed for use. Different application environments may provide different sets of panels, frameworks, libraries, and services for supporting applications.

First application environment 200 may be a “native” environment of multi-modal device 100, such as a mobile-telephone environment, a PDA environment, or the like. First application environment 200 may operate on multi-modal device 100. First application environment 200 may present user interface 140 on display 135 and may present a selected panel from the set of panels 125 on user interface 140. First application environment 200 may also present docking bar 145 on user interface 140.

Second application environment 205 may be an operating system environment, such as a Linux operating system environment. Second application environment 205 may operate on multi-modal device 100. Second application environment 205 may present user interface 120 on display 115 of hardware module 105. Second application environment 205 may display user interface 120 if multi-modal device 100 is docked to hardware module 105 as shown in FIG. 1. Second application environment 205 may not display user interface 120 on either of multi-modal device 100 or display module 105 if multi-mode device 100 is not docked to hardware module 105. Second application environment 205 displays user interface 140 on user interface 120 according to one embodiment (see FIG. 1). Second application environment 205 may display the set of panels 125 on user interface 120 according to another embodiment (see FIG. 1). Second application environment 205 may also display docking bar 130 on user interface 140 according to another embodiment (see FIG. 1).

Display 115 of hardware module 105 may be larger (height and/or width) than display 135 of multi-modal device 100, and user interface 120 may be larger than user interface 140. As described briefly above, second application environment 205 may display user interface 140 and the set of panels 125 on user interface 120. With the set of panels 125 displayed on user interface 120 in relatively large display 115, second application environment 205 provides for relatively large environment for manipulating panels 125. With panels 125 displayed on user interface 120, the manipulations of panels 125 may be viewed as a whole on user interface 120, whereas with a single panel displayed on user interface 140, manipulations of panels 125 as a whole may not be viewed collectively, or may not be as viewed collectively in a convenient manner. Displaying the set of panels 125 on user interface 120 on relatively large display 115 therefore provides for ease in manipulating panels 125 and visually tracking the manipulations of panels 125. While second application environment 205 is described immediately above as displaying the set of panels 125, according to some embodiments second application environment may display a sub-set of panels 125 (e.g., two or more panels) on user interface 120. Manipulations made to a selected panel (e.g., panel 125b shown in FIG. 1) in first application environment 200 and displayed on user interface 140 are made to the same selected panel (e.g., panel 125b) in second application environment 205 and displayed on user interface 120.

A variety of changes may be made to one or more panels in the set of panels 125 according to various embodiments. For example, a change to a selected panel interface in the set of panels 125 may include the placement of a home screen object on the selected panel. The communication may indicate the placement of the home screen object (i.e., change) on the selected panel. The home screen object may be an application icon for an application, a shortcut, a bookmark, a widget, a folder, wallpaper, etc. According to a further example, a home screen object might be moved from a first selected panel in the set of panels 125 to a second selected panel in the set of panels 125. The communication may indicate the removal of the home screen object from the first selected panel and the placement of the home screen object on the second selected panel. Other changes to panels in the set of panels 125 may include reordering the positions of two or more panels with respect to one another. Other changes to the panels in the set of panels 125 may include the removal of a selected panel from the set of panels 125, or the addition of a new panel to the set of panels 125. The communication may indicate the reordering of panels, the removal of panels, or the addition of panels.

Changes made to the set of panels 125 in first application environment 200 may be made while multi-modal device 100 is docked to hardware module 105, or may be made while multi-modal device 100 is not docked to hardware module 105. Changes made to the set of panels 125 in first application environment 200 while multi-modal device 100 is not docked to hardware module 105 may be made to (i.e., synchronized with) the corresponding panels in second application environment 205 after multi-modal device 100 is docked to hardware module 105.

Second application environment 205 may register to receive communications issued by first application environment 200, and thereafter listen for communications issued by first application environment 200 where the communications indicate one or more changes to one or more panels in the set of panels 125. A communication issued by first application environment 200 may include panel information (sometimes referred to as configuration information) for changes to a panel. Communications exchanged by first and second application environments 200 and 205 are described in further detail below.

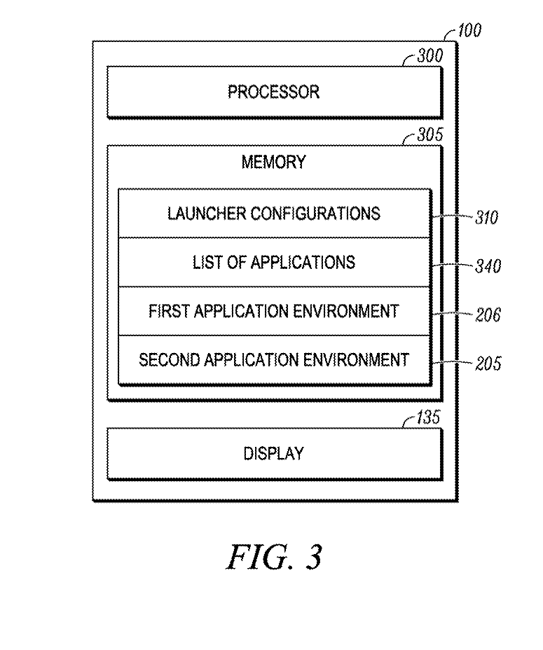

FIG. 3 depicts a system diagram of multi-modal device 100 according to one embodiment. Multi-modal device 100 may include a processor 300, a computer readable storage medium (e.g., a non-transitory computer readable storage medium) 305, and display 135. For convenience, computer readable storage medium 305 is referred to as “memory” 305. Memory 305 may include instructions (e.g., computer code) for controlling processor 300 to be operable to execute the various method embodiments described herein. The instructions stored in memory 305 may embody the various method embodiments described herein.

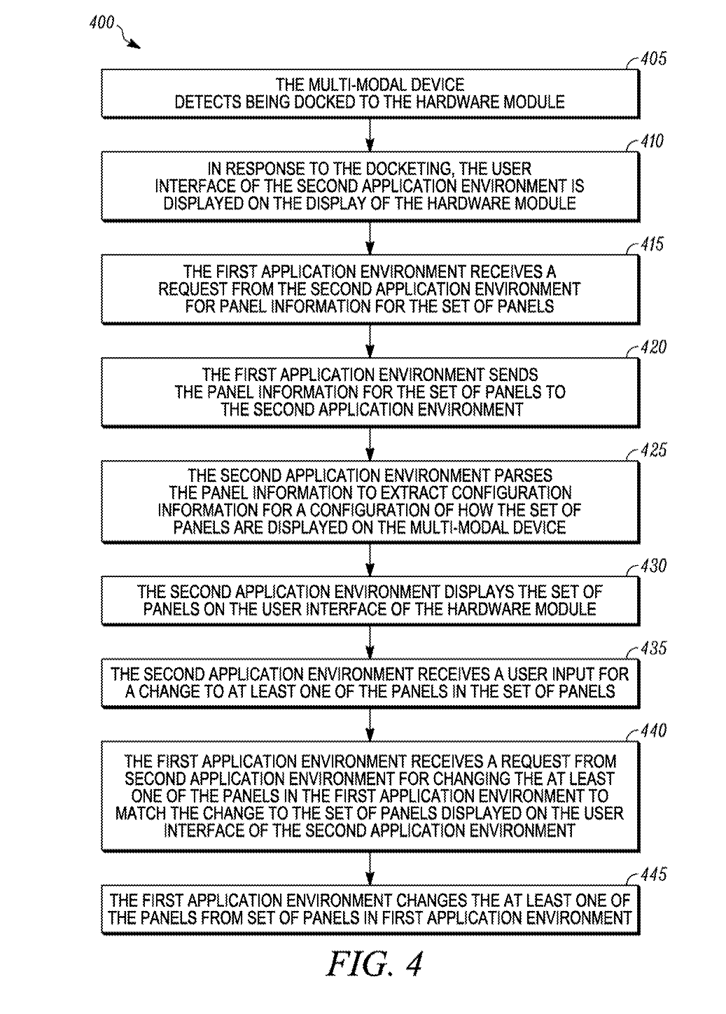

FIG. 4 depicts a high-level flow diagram 400 of a method for arranging a panel in the set of panels 125 in first application environment 200 via arrangement of the panel in second application environment 205 according to one embodiment. The high-level flowchart represents an example embodiment, and those of skill in the art will understand that various steps shown in the simplified flow chart may be added and/or combined without deviating from the purview of the described embodiment.

At 405, multi-modal device 100 detects being docked to hardware module 105.

At 410, in response to the docking, user interface 120 is displayed on display 115 of hardware module 105 where the user interface is displayed by second application environment 205, which operates on multi-modal device 100. According to at least one embodiment, multi-modal device 100 operates as a processing module for second application environment 205, and hardware module 105 does not operate as a processing module for second application environment 205. Hardware module 105 operates as a display for second application environment 205.

At 415, first application environment 200 receives a request from second application environment 205 for panel information for the set of panels 125, which are managed by first application environment 200 for display (e.g., one at a time) on display 135.

At 420, first application environment 200 sends the panel information for the set of panels 125 to second application environment 205.

At 425, second application environment 205 parses the panel information received from first application environment 200 to extract information for a configuration of how the set of panels 125 are displayed on display 135 and for a configuration of how the launcher objects are displayed in the set of panels 125 on display 135.

At 430, second application environment 205 displays the set of panels on user interface 120 on display 115 of hardware module 105. According to an alternative embodiment, second application environment 205 may display fewer than all of the panels in the set of panels 125 on user interface 120. Second application environment 205 may also display an image of user interface 140 of multi-modal device 100 on user interface 120. Second application environment 205 may also display docking bar 130, which may display each of the launcher objects in the set of panels 125 and each of the launcher objects in docking bar 145. The panel information may include information for the launcher objects displayed on the set of panels 125 in first application environment 200 and displayed on docking bar 145 in first application environment 200. Selection of one of the launcher objects in docking bar 130 launches an associated application, bookmark, widget, etc. on multi-modal device 100. The launched application, bookmark, widget, etc. may be displayed on user interface 140, and may be displayed on image of user interface 140 displayed on user interface 120.

At 435, user interface 120 of second application environment 205 receives a user input for a change to at least one of the panels in the set of panels 125 displayed on user interface 120. The change to the panel may include the removal of a launcher object from one of the panels, the placement of a launcher object one of the panels, the rearrangement of two or more launcher objects on two or more of the panels, the movement of a launcher object from a panel to docking bar 130, the movement of a launcher object from docking bar 130 to a panel, the addition of a panel to the set of panels 125, the removal of a panels from the set of panels 125, the rearrangement of two or more panels in the set of panels 125, etc.

At 440, first application environment 200 receives a request from second application environment 205 for changing the at least one of the panels in the set of panels 125 in first application environment 200 to match the change to the set of panels 125 as displayed on user interface 120 of second application environment 205.

At 445, first application environment 200 changes the at least one of the panels from set of panels 125 in first application environment 200 to match the change to the at least one of the panels in second application environment 205 occurring at 435. If the at least one panel changed in second application environment 205 is the home-screen panel in first application environment of multi-modal device 100, then the change to the at least one panel is displayed on the home-screen panel in first application environment 200. Multi-modal device 100 may save the change to the at least one panel so that the change may be subsequently displayed in the at least one panel on user interfaces 120 and 140 of first and second application environments 200 and 205.

Referring again to FIG. 2, first application environment 200 may include a portal service manager 320, which may include a portal application 325 and a portal service 330. First application environment 200 may also include a package manager 335. According to one embodiment, package manager 335 stores and manages a list of applications 340 for applications that operate in the first application environment. Package manager 335 may also store and manage the set of launcher configurations 310.

Second application environment 205 may include a communication manager 350, which may be the Webtop Intent Framework communication manager of Motorola. Second application environment 205 may also include an application tray manger 355 that manages user interface 120. According to one embodiment, when multi-modal device 100 is docked to hardware module 105, communication manager 350 registers with portal service manger 320 to receive communications form portal service manager 320. Subsequent to communication manager 350 registering with portal service manger 320 to receive communications, communication manager 350 listens for communications from portal service manager 320s where the communications may include information for changes to the set of panels 125, which are described above. The registration to receive communications may be viewed as a request for information that indicates changes to the set of panels 125.

Referring again to FIG. 3, first application environment 200 may include a portal service manager 320, which may include a portal application 325 and a portal service 330. First application environment 200 may also include a package manager 335. According to one embodiment, package manager 335 stores and manages a list of applications 340 for applications that operate in the first application environment. Package manager 335 may also store and manage the set of launcher configurations 310.

Second application environment 205 may include a communication manager 350, which may be the Webtop Intent Framework communication manager of Motorola. Second application environment 205 may also include an application tray manger 355 that manages user interface 120. According to one embodiment, when multi-modal device 100 is docked to hardware module 105, communication manager 350 registers with portal service manger 320 to receive communications form portal service manager 320. Subsequent to communication manager 350 registering with portal service manger 320 to receive communications, communication manager 350 listens for communications from portal service manager 320s where the communications may include information for changes to the set of panels 125, which are described above. The registration to receive communications may be viewed as a request for information that indicates changes to the set of panels 125.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations, and equivalents may be employed without departing from the scope of the invention as defined by the claims.

What is claimed is:

1. A method operable on a multi-modal device for arranging a set of panels in a first application environment via arrangement of the set of panels in a second application environment, the method comprising:
detecting a docking of the multi-modal device to a hardware module;
displaying, in response to the docking, on the hardware module a user interface for the second application environment operating on the multi-modal device;
receiving a request, at the first application environment, for configuration information for the set of panels of the first application environment from the second application environment;
sending, from the first application environment, the configuration information to the second application environment;
displaying in the user interface for the second application environment the set of panels based on the configuration information;
receiving, via the user interface, an input to change at least one of the panels in the second application environment;
receiving a request, at the first application environment, for changing the at least one of the panels in the first application environment from the second application environment based on the input; and
making a change to the at least one of the panels in the first application environment to match the change of the at least one of the panels in the second application environment based on the request for changing the at least one of the panels.

2. The method of claim 1, wherein the input to change the at least one of the panels is for: moving a home screen object to the at least one of the panels from another panel included in the set of panels, adding a home screen object to the at least one of the panels, removing a home screen object from the at least one of the panels, or updating a home screen object displayed in the at least one of the panels, or resizing a home screen object displayed in the at least one of the panels.

3. The method of claim 2, further comprising displaying in the user interface the change in the at least one of the panels in the second application environment based on receiving the input to change the at least one of the panels.

4. The method of claim 2, wherein the home screen object is an application icon, a shortcut, a bookmark, a shortcut, a folder, a widget, or wallpaper.

5. The method of claim 1, further comprising displaying the change of the at least one of the panels in the first application environment if the at least one of the panels is displayed in the first application environment on the multi-modal device.

6. The method of claim 5, further comprising displaying in the user interface an image of the first application environment.

7. The method of claim 1, further comprising saving the change to the at least one of the panels in the first application environment.

8. The method of claim 1, wherein making the change to the at least one of the panels in the first application environment to match the change of the at least one of the panels in the second application environment includes: adding a home screen object to the at least one of the panels in the first application environment to match adding the home screen object in the second application environment, moving a home screen object to the at least one of the panels from another panel included in the set of panels, adding a home screen object to the at least one of the panels, removing a home screen object from the at least one of the panels, updating a home screen object displayed in the at least one of the panels, or resizing a home screen object displayed in the at least one of the panels.

9. The method of claim 1, wherein the input to change the at least one of the panels in the second application environment is for adding the at least one of the panels to the set of panels in the second application environment.

10. The method of claim 1, wherein the input to change the at least one of the panels in the second application environment is for removing the at least one of the panels from the set of panels in the second application environment.

11. The method of claim 1, wherein the input to change the at least one of the panels in the second application environment is for moving the at least one of the panels with respect to another panel, which is included in the set of panels.

12. A non-transitory computer-readable storage medium comprises instructions for arranging a set of panels in a first application environment via arrangement of the set of panels in a second application environment, the instructions for controlling a multi-modal device to be operable for:
detecting a docking of the multi-modal device to a hardware module;
displaying, in response to the docking, on the hardware module a user interface for the second application environment operating on the multi-modal device;
receiving a request, at the first application environment, for configuration information for the set of panels of the first application environment from the second application environment;
sending, from the first application environment, the configuration information to the second application environment;
displaying in the user interface for the second application environment the set of panels based on the configuration information;
receiving, via the user interface, an input to change at least one of the panels in the second application environment;
receiving a request, at the first application environment, for changing the at least one of the panels in the first application environment from the second application environment based on the input; and
making a change to the at least one of the panels in the first application environment to match the change of the at least one of the panels in the second application environment based on the request for changing the at least one of the panels.

13. The non-transitory computer-readable storage medium of claim 12, wherein the input to change the at least one of the panels is for: moving a home screen object to the at least one of the panels from another panel included in the set of panels, adding a home screen object to the at least one of the panels, removing a home screen object from the at least one of the panels, updating a home screen object displayed in the at least one of the panels, or resizing a home screen object displayed in the at least one of the panels.

14. The non-transitory computer-readable storage medium of claim 13, wherein the instruction for controlling the multi-modal device are further operable for displaying the change in the second application environment based on receiving the input to change the at least one of the panels.

15. The non-transitory computer-readable storage medium of claim 12, wherein the instruction for controlling the multi-modal device are further operable for displaying the change of the at least one of the panels in the first application environment if the at least one of the panels is displayed in the first application environment on the multi-modal device.

16. The non-transitory computer-readable storage medium of claim 12, wherein the instruction for controlling the multi-modal device are further operable for:
receiving, via the user interface, an input for adding an additional panel to the set of panels in the second application environment;
receiving a request by the first application environment for adding the additional panel to the set of panels in the first application environment from the second application environment; and
adding the additional panel to the set of panels in the first application environment.

17. A multi-modal device for arranging a set of panels in a first application environment via arrangement of the panel in a second application environment, the multi-modal device comprising:
a processor for operating the first application environment and the second application environment; and
a non-transitory computer readable medium for storing instructions for controlling the processor to be operable for:
detecting a docking of the multi-modal device to a hardware module;
displaying, in response to the docking, on the hardware module a user interface for the second application environment operating on the multi-modal device;
receiving a request, at the first application environment, for configuration information for the set of panels of the first application environment from the second application environment;
sending, from the first application environment, the configuration information to the second application environment;
displaying in the user interface of the second application environment the set of panels based on the configuration information;
receiving, via the user interface, an input to change at least one of the panels in the second application environment;
receiving a request, at the first application environment, for changing the at least one of the panels in the first application environment from the second application environment based on the input; and
making a change to the at least one of the panels in the first application environment to match the change of the at least one of the panels in the second application environment based on the request for changing the at least one of the panels.

18. The multi-modal device of claim 17, wherein the input to change the at least one of the panels is for: moving a home screen object to the at least one of the panels from another panel included in the set of panels, adding a home screen object to the at least one of the panels, removing a home screen object from the at least one of the panels, updating a home screen object displayed in the at least one of the panels, or resizing a home screen object displayed in the at least one of the panels.

19. The multi-modal device of claim 18, wherein instructions are for further controlling the processor to be operable for displaying the change of the at least one of the panels in the first application environment if the at least one of the panels is displayed in the first application environment on the multi-modal device.

20. The multi-modal device of claim 17, wherein the instructions are for further controlling the processor to be operable for displaying the change of the at least one of the panels in the first application environment if the at least one of the panels is displayed in the first application environment on the multi-modal device.
